(19) United States
(12) Patent Application Publication
(10) Pub. No.: US 2025/0030559 A1
(43) Pub. Date: Jan. 23, 2025

(54) CRYPTOGRAPHY AS A SERVICE

(71) Applicant: VMware LLC, Palo Alto, CA (US)

(72) Inventors: SEAN JAMES HUNTLEY, Sydney (AU); DANIEL JAMES BEVERIDGE, Valrico, FL (US); DAVID E OTT, Chandler, AZ (US); SHIVALI SHARMA, Pune (IN); VASANTHA KUMAR DHANASEKAR, Pune (IN)

(21) Appl. No.: 18/377,836

(22) Filed: Oct. 9, 2023

(30) Foreign Application Priority Data
Jul. 20, 2023 (IN) 202341048999

(51) Int. Cl. H04L 9/32

(52) U.S. Cl. CPC H04L 9/3263; H04L 9/3236

(57) ABSTRACT

The disclosure provides an approach for providing cryptography as a service. Embodiments include receiving, by a cryptographic provider component, policy information. Embodiments include receiving, by the cryptographic provider component, requests from a plurality of applications to perform cryptographic operations, wherein the plurality of applications comprise separate processes from the cryptographic provider component. Embodiments include selecting, by a cryptographic router of the cryptographic provider component, based on the policy information and information associated with the requests, one or more cryptographic implementation components for servicing each request of the requests.

### RELATED APPLICATIONS

Benefit is claimed under 35 U.S.C. 119(a)-(d) to Foreign Application Serial No. 202341048999 filed in India entitled “CRYPTOGRAPHY AS A SERVICE”, on Jul. 20, 2023, by VMware, Inc., which is herein incorporated in its entirety by reference for all purposes.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources (e.g., involving the transmission of larger amounts of information over a network). Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, in order to perform various cryptographic functions (e.g., encryption of data, establishing secure connection channels, and/or the like). In some cases, weaknesses in particular algorithms may be discovered over time such as due to advances in computing technology (e.g., a particular algorithm may be susceptible to being compromised through the use of computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

The rise of quantum computing has raised the possibility of additional issues related to cryptography. For example, the high levels of computational power provided by quantum computing may enable nefarious actors to more easily access data secured with existing cryptographic algorithms, thereby gaining access to sensitive data that was previously believed to be secure.

The dynamic nature of computing technology and the variety of threats that exist to data security necessitate a continuous adapting of cryptography to meet these new circumstances and threats. Furthermore, laws and/or regulations may require certain types of cryptography to be utilized in certain contexts. Thus, compliance with such laws and/or regulations may further necessitate adopting of new and/or different types of cryptographic algorithms.

Conventional software applications are generally designed to implement and/or utilize particular cryptographic algorithms. These algorithms may be customizable in certain respects, but there is generally no convenient mechanism for changing the cryptographic algorithms utilized by an application without modifying the base code of the application, essentially requiring portions of the application code to be rewritten, which is time consuming and difficult. Such code modifications are expensive and error-prone, particularly when done on a regular basis to address the ever-changing landscape of computing security.

As such, there is a need for improved cryptography techniques that allow for extensibility, flexibility, and cryptographic agility.

### BRIEF DESCRIPTION OF THE DRAWINGS

FIG. 1 is an illustration of example computing components related to cryptography as a service, according to embodiments of the present disclosure.

FIG. 2 is an illustration of an example related to cryptography as a service.

FIG. 3 is an illustration of another example related to cryptography as a service.

FIG. 4 depicts example operations related to cryptography as a service according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to providing cryptography as a service. In particular, the present disclosure provides an approach for enabling cryptographic agility via an out-of-process cryptographic agility system that enables dynamic configuration, extensibility, automated selection and implementation of optimal cryptographic techniques, load balancing, and the like.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate out-of-process components. For example, a cryptographic agility system described herein may expose an application programming interface (API) providing generic cryptographic methods that can be invoked by applications in order to provide dynamic and performant cryptographic functionality.

Thus, rather than relying on cryptographic functionality provided by an application, embodiments of the present disclosure involve dynamic cryptography that is provided by a separate out-of-process cryptographic agility system. For example, the cryptographic agility system may select and/or configure cryptographic algorithms, such as based on contextual information and/or policies. In certain embodiments, the cryptographic agility system dynamically determines which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, types of mathematical operations to be performed on the encrypted data, and/or the like.

Dynamically selecting cryptographic techniques based on resource constraints is described in more detail in U.S. patent application Ser. No. 17/385,287, filed Jul. 26, 2021, the contents of which are incorporated by reference herein in their entirety.

For example, policies may be defined by users (e.g., administrators), and may specify rules for selecting and/or configuring (e.g., setting particular parameters of) cryptographic techniques. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application sends data (e.g., whether encrypted directly by the application or not), and contextual information indicates that the data is to be transmitted to a device on a public network, then the cryptographic agility system, in certain embodiments, will select a cryptographic algorithm tagged as a high-security algorithm, such as with a security rating of 8 or higher. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard.

In yet another example, cryptographic techniques are tagged with indications of whether they have certain characteristics or support certain configurations, and a policy may specify that all data that is to be transmitted as part of a data aggregation process is to be encrypted using a cryptographic technique that does or does not have one or more particular characteristics or configurations. Thus, if the cryptographic agility system receives a request to encrypt an item of data for a data aggregation process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from applications that rely on cryptographic functionality, techniques described herein provide flexibility and extensibility, thus allowing cryptographic algorithms to be continually updated, changed, and otherwise configured without requiring modifications to the applications themselves. Accordingly, changing circumstances and new threats may be addressed in a dynamic and efficient manner, and computing security may thereby be improved.

In some embodiments, one or more cryptographic provider components of the cryptographic agility system include logic for analyzing information associated with a cryptographic request according to rules and/or policies in order to select among a library of available cryptographic techniques (e.g., that may be registered with the cryptographic agility system by an administrator). A cryptographic provider component may include a cryptographic router that selects between different cryptographic implementation components for performing selected cryptographic techniques. For example, as requests form one or more applications are received at the cryptographic provider, the cryptographic router may ensure that the requests are handled by appropriate modules that perform cryptographic techniques. In some embodiments, cryptographic implementation components are executable components that perform particular cryptographic functionality, such as encrypting or decrypting data using particular cryptographic algorithms. The cryptographic implementation components may be loaded as needed based on selection of cryptographic techniques for servicing particular requests. In some cases, more than one cryptographic implementation component that performs a given cryptographic technique may be loaded, and the cryptographic router may perform load balancing and/or prioritization functionality to assign requests to particular cryptographic implementation components.

Furthermore, the cryptographic agility system may include a provider routing component that routes requests to cryptographic providers. For example, the provider routing component may be upstream of a plurality of cryptographic providers, and may perform load balancing and/or prioritization functionality in assigning requests to cryptographic providers. In some cases, the provider routing component may launch new cryptographic providers as needed, such as when existing cryptographic provider(s) reach a certain amount of load or a certain number of pending requests. Alternatively, rather than distributing requests across a plurality of cryptographic providers, a single cryptographic prover may comprise a plurality of threads, and requests may be distributed across the plurality of threads, such as to achieve load balancing and/or prioritization objectives.

Priorities of requests may be determined by the cryptographic routers and/or the provider routing component based, for example, on policies, the types of data being encrypted, the endpoints making the requests, the destinations to which encrypted data is being sent, geographic locations, the types of cryptographic operations requested, and/or the like. Requests may be moved by a cryptographic router from one cryptographic implementation component to another or moved by a provider routing component from one cryptographic provider to another in certain cases, such as due to load or other conditions. For example, if a particular cryptographic request involves multiple successive encryption operations and circumstances change such that the particular cryptographic request is better suited for a different cryptographic implementation component or a different cryptographic provider, the request may moved after completion of a particular cryptographic operation such that subsequent cryptographic operations for the request are handled by a different component or different provider.

Provider routing components and/or cryptographic providers may be located on the same device as an application and/or may be located on one or more different devices.

In a cryptographic agility system, an initial stage of selecting a cryptographic technique may involve ensuring that the security requirements for a given cryptographic operation, such as a level of security required by policy and/or context information, are met. In some cases, there may be multiple algorithms and/or configurations of algorithms that meet these requirements. Resource-related considerations may also be factored into the determination of which algorithms and/or configurations to use, such as based on device and/or network performance metrics and/or capability information. In one example, the cryptographic agility system selects a cryptographic technique with a highest security rating of those that comply with all relevant policies and/or resource constraints related to communications between the application and the client device.

The cryptographic agility system may also consider whether privacy-preservation with respect to an endpoint is required, such as when sensitive data is sent to an untrusted aggregator device to perform aggregation operations. In such cases, the cryptographic agility system may select a privacy-preserving cryptographic technique, such as involving homomorphic encryption and/or confidential computing. Furthermore, if homomorphic encryption is selected, the cryptographic agility system may determine which homomorphic encryption technique to use based on which mathematical operations are to be performed on the encrypted data, such as by an aggregator device. For example, different homomorphic encryption algorithms may allow different types of mathematical operations (e.g., addition, multiplication, or the like) to be performed on the encrypted data while maintaining homomorphic properties. However, homomorphic encryption techniques that support more types of mathematical operations, such as fully homomorphic encryption techniques, tend to be resource-intensive. Thus, some embodiments involve the cryptographic agility system selecting the most resource-efficient homomorphic encryption algorithm that supports the required mathematical operations.

Thus, the cryptographic agility system may select algorithms and/or configurations of algorithms that are best suited to the context, resource availability, performance, and/or capabilities of the applications, devices, and/or networks associated with communications between the application and the client device. Furthermore, the cryptographic agility system may dynamically provision an optimal number of cryptographic providers and/or cryptographic implementation components and dynamically route requests to cryptographic providers and/or cryptographic implementation components based on a variety of factors, such as to optimize load and/or achieve other policy objectives.

In some cases, cryptographic algorithms and/or configurations of algorithms may be dynamically switched over time based on changing circumstances. For example, if a client device moves from a low-latency network to a high-latency network (such as the latency of a network that device is coupled to changes), the cryptographic agility system may switch from a cryptographic algorithm that requires a large amount of network resources to an alternative cryptographic algorithm that requires smaller amounts of network resources (e.g., a lower security algorithm that still meets the security requirements for the cryptographic operation), and may switch back if the device moves again into a lower-latency network. These changing circumstances may be determined by the cryptographic agility system based on contextual information related to each communication from the application to the client device and vice-versa. These switches may involve a cryptographic router moving a request from one cryptographic implementation component to another and/or a provider routing component moving a request from one cryptographic provider to another.

Embodiments of the present disclosure improve upon conventional cryptography techniques in which cryptographic algorithms are pre-determined for applications (e.g., at design time) by allowing cryptographic algorithms and/or configurations to be dynamically selected and changed over time based on contextual information, even if an application was not designed to support such functionality. For example, utilizing an out-of-process cryptographic agility system to dynamically select cryptographic algorithms and/or configurations based on contextual and policy information, techniques described herein improve the security and functioning of devices and networks on which cryptographic operations are performed, such as by, in certain embodiments, ensuring that the most secure and updated cryptographic techniques that are consistent with device and network constraints may be utilized by an application, even if such techniques were not available at the time the application was developed.

Additionally, techniques described herein may facilitate an organization's use of uniform policy configuration (e.g., a suite of coordinated policies), such as to orchestrate cryptographic usage across many hosts (e.g., for federated data centers deployed worldwide). Embodiments of the present disclosure may also be used to facilitate migration to new cryptographic algorithms at scale and/or to remove deprecated cryptographic algorithms from use in a centralized and coordinated manner.

Furthermore, by dynamically routing requests to cryptographic providers and/or to cryptographic implementation components to achieve load balancing and/or other policy objectives, techniques described herein improve the functioning of software applications as well as the underlying physical computing devices involved, such as by reducing load, increasing throughput, and ensuring that high-priority requests are serviced promptly.

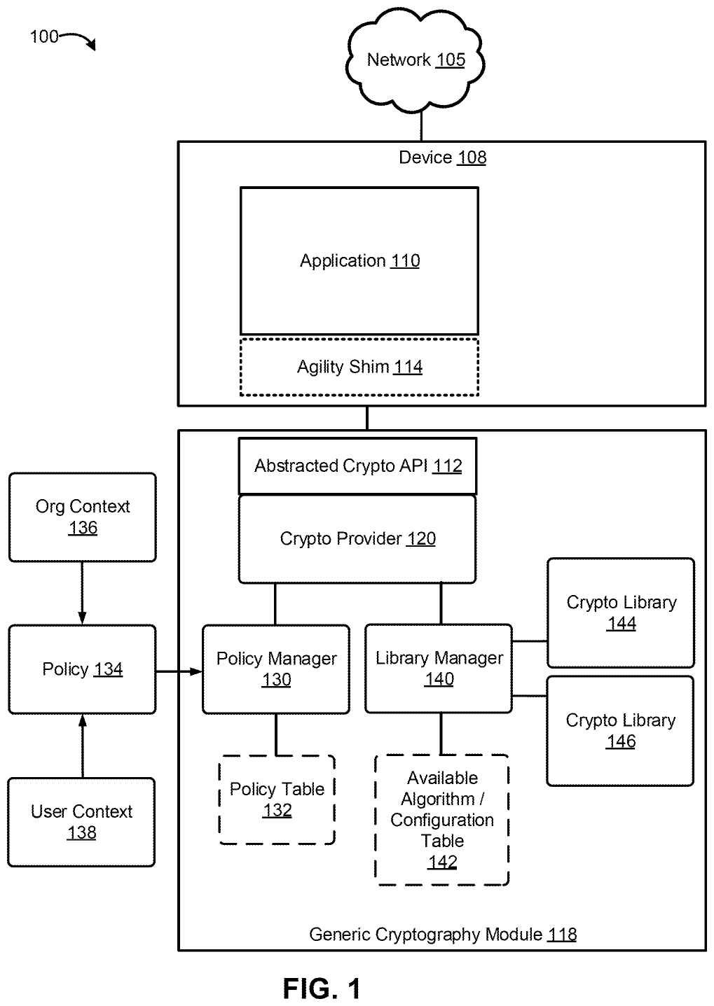

FIG. 1 is an illustration 100 of example computing components related to providing cryptography as a service, according to embodiments of the present disclosure.

A device 108 is connected to a network 105. In certain embodiments, device 108 may be a physical or virtual computing device, such as a server computer, that hosts an application 110. In some embodiments, device 108 may be a virtual computing instance (VCI), such as a virtual machine (VM) or container that runs on a physical host computer. Network 105 may be any sort of network over which data may be transmitted, such as a local area network (LAN), cellular network, satellite-based network, the Internet, or the like. It is noted that application server 108 is included as an example computing device on which application 110 and/or associated components may be located, and other types of devices may also be used.

Application 110 generally represents a software application that requires cryptographic functionality. For example, application 110 may rely on cryptographic functionality to encrypt data that it transmits over a network (e.g., network 105), such as to one or more client devices that interact with application 110 (e.g., accessing content provided by application 110) or to one or more aggregator devices (e.g., as part of a federated learning process). While conventional techniques generally involve direct integration of cryptographic libraries with applications that rely on cryptographic functionality, techniques described herein involve abstracting cryptographic functionality away from applications. As such, an abstracted crypto application programming interface (API) 112 is provided as a means of facilitating cooperation between application 110 and a separate cryptographic agility system.

hApplication 110 may call generic cryptographic functions of abstracted crypto API 112 in order to invoke particular cryptographic functionality, and the cryptographic agility system may select cryptographic techniques and perform cryptographic operations in response to the function invocations based on contextual information.

The cryptographic agility system includes abstracted crypto API 112 and, in some embodiments, an optional agility shim 114, as well as crypto provider 120, policy manager 130, and library manager 140. In some embodiments, while depicted as separate components, agility shim 114, abstracted crypto API 112, policy manager 130, and/or library manager 140 may be part of crypto provider 120. In certain embodiments, abstracted crypto API 112 and/or agility shim 114 are part of a proxy component located on application server 108. In alternative embodiments, abstracted crypto API 112 and/or agility shim 114 may be located on a proxy component separate from application server 108, such as on the same device as generic cryptography module 118 or a different computing device. Alternatively, abstracted crypto API 112 and/or agility shim 114 are not part of a proxy component.

Agility shim 114 generally intercepts API calls (e.g., calls to functions of abstracted crypto API 112) and redirects them to crypto provider 120 via abstracted crypto API 112. Shims generally allow new software components to be integrated with existing software components by intercepting, modifying, and/or redirecting communications. As such, agility shim 114 allows application 110 (or another component, such as a proxy component) to interact with crypto provider 120 even though application 110 itself may have no knowledge of crypto provider 120. For instance, application 110 may make cryptographic function calls (e.g., requesting that an item of data be encrypted), and these function calls may be intercepted by agility shim 114 (e.g., if such a shim is needed) and redirected to crypto provider 120 via the abstracted crypto API 212 exposed by crypto provider 120. For example, if agility shim 114 is needed, it may intercept calls to existing crypto modules and translate such calls to generic cryptographic function calls to abstracted crypto API 112. Otherwise, if agility shim 114 is not needed, application 110 may directly make generic cryptographic function calls to abstracted crypto API 112.

It is noted that while embodiments of the present disclosure are depicted on device 108 and generic cryptography module 118, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 118 comprises a physical or virtual computing device, such as a server computer, on which components of the cryptographic agility system, such as crypto provider 120, policy manager 130, and/or library manager 140, reside. For example, generic cryptography module 118 may represent a VCI or a physical computing device. Generic cryptography module 118 may be connected to network 105 and/or one or more additional networks.

Crypto provider 120 generally performs operations related to dynamically selecting cryptographic techniques (e.g., based on contextual information related to requests for cryptographic operations), performing the requested cryptographic operations according to the selected techniques, and providing results of the operations to the requesting components or to other recipient components. Cryptographic techniques may include cryptographic algorithms (e.g., included in one or more libraries) and/or specific configurations of cryptographic algorithms, as described herein. In some embodiments, the cryptographic agility system is located on the same device as application 110, while in other embodiments the cryptographic agility system is located on a separate device, such as on a server that is accessible over a network. According to certain embodiments, policies are defined by an enterprise administrative team deploying an application such as application 110, rather than being defined by an application user. Accordingly, policies may be used to determine (e.g., on behalf of application users) which cryptographic techniques to use (e.g., based on organizational policies). Policy-based selection of cryptographic techniques may be based on contextual information related to a cryptographic request.

In certain aspects, crypto provider 120 has two major subsystems, policy manager 130 and library manager 140. Policy manager 130 performs operations related to cryptographic policies, such as receiving policies defined by users and storing information related to the policies in a policy table 132. According to certain embodiments, a centralized policy control server may orchestrate policy across a plurality of generic cryptography modules, such as including generic cryptography module 114. For example, an administrator or other user may configure one or more policies at a centralized policy control server, and the one or more policies may be distributed to a plurality of generic cryptography modules for storage by corresponding policy managers, such as including policy manager 230. In an example, a policy 134 is based on one or more of an organizational context 136 and a user context 138 related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context 136 may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, policy 134 may indicate that if a cryptographic request is received in relation to a device (e.g., client device or other device, such as application server 108) associated with a particular geographic region, associated with a particular industry, and/or within the jurisdiction of a particular governmental entity, then crypto provider 120 must select a cryptographic technique that meets one or more conditions (e.g., having a particular security rating and/or being configured to protect against particular types of threats) in order to comply with relevant laws, regulations, or mandates.

User context 138 may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, policy 134 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), associated with a device with particular capabilities or other attributes (e.g., a client or server device having a certain amount of processing or memory resources, or having an accelerator), and/or in relation to a device in a particular location (e.g., geographic location) or type of networking environment (e.g., cellular network, satellite-based network, land network, or the like), then crypto provider 120 should select a cryptographic technique that meets one or more conditions. In some cases, a policy 134 may relate to resource constraints (e.g., based on available processing, memory, or network resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 120 selects cryptographic techniques based on resource constraints independently of policy manager 130 (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. Policies may also relate to privacy-preservation, such as requiring homomorphic encryption or confidential computing, or specific types of homomorphic encryption or confidential computing, under certain circumstances (e.g., when data is being sent to an untrusted aggregator device). In certain embodiments, a policy may simply specify an allowed list of ciphers or an allowed list of cryptographic technique characteristics. In one example, once all cryptographic techniques meeting the security requirements for a cryptographic request are identified based on policies, a cryptographic technique is selected from these policy-compliant cryptographic techniques based on resource constraints.

Policy table 132 stores information related to policies, such as policy 134. In some embodiments, policy table 132 maps various contextual conditions (e.g., relating to organizational context and/or user context) to cryptographic technique characteristics (e.g., whether techniques are privacy-preserving, homomorphic, involve confidential computing, require specialized hardware, support certain mathematical operations, have certain security ratings, protect against certain threats, have certain resource utilization ratings, and the like). For example, a contextual condition may be the use of a certain type of application, the requirement that privacy be preserved during computation, the requirement of certain mathematical operations to be performed on encrypted data, a certain type of data, or a particular geographic location. A cryptographic technique characteristic may be, for example, whether the cryptographic technique is homomorphic, whether the cryptographic technique involves confidential computing and/or requires certain specialized hardware, supported mathematical operations, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, policy table 132 may be used to determine whether the cryptographic requests are associated with any characteristics included in policies and, if so, what cryptographic technique characteristics are required by the policies for servicing the requests.

Library manager 140 generally manages cryptographic libraries containing cryptographic algorithms. For example crypto libraries 244 and 246 each include various cryptographic algorithms and/or techniques, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms, and/or confidential computing techniques) may be registered with library manager 240 along with information indicating characteristics of the cryptographic techniques. Examples of algorithms include the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, data encryption standard (DES), triple DES, advanced encryption standard (AES), Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, including homomorphic and non-homomorphic encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. Cryptographic techniques may also involve confidential computing techniques, which may rely on the use of specialized hardware, such as Intel® Software Guard Extensions (SGX), Project Amber, Intel® Trust Domain Extensions (TDX), Arm® TrustZone®, and/or the like. A characteristic of a cryptographic technique may be, for example, whether the cryptographic technique is privacy-preserving, whether the cryptographic technique involves confidential computing, whether the cryptographic technique is homomorphic, what types of specialized hardware are required for the cryptographic technique, supported mathematical operations, whether the technique is Turing complete (e.g., supports all types of mathematical operations, such as a fully homomorphic encryption scheme), a security rating, a resource requirement rating, whether the technique requires an accelerator, whether the technique is quantum-safe, or the like. A cryptographic technique may include more than one cryptographic algorithm and/or configuration. For example, one cryptographic technique may involve a confidential computing technique in conjunction with an encryption algorithm that is to be used for encrypting data for transmission to the confidential computing component and for encrypting the result of computations performed by the confidential computing component. In an example, each cryptographic technique is tagged (e.g., by an administrator) based on characteristics of the technique, such as with an indication of whether the cryptographic technique is privacy-preserving, whether the cryptographic technique involves confidential computing, whether the cryptographic technique is homomorphic, what types of specialized hardware are required for the cryptographic technique, an indication of supported mathematical operations, a security rating, an indication of threats protected against by the technique, indications of the resource requirements of the technique, and/or the like.

Information related to cryptographic techniques registered with library manager 140 is stored in available algorithm/configuration table 142. For instance, available algorithm/configuration table 142 may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “homomorphic encryption algorithms configured to support addition.” Thus, if tags are associated with this type (e.g., including supported mathematical operations, security ratings, recourse requirement ratings, and the like), any specific cryptographic techniques of this type (being homomorphic encryption algorithms, and being configured to support addition) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries to be registered and deregistered with library manager 140 on an ongoing basis, and to be associated with metadata such as tags that can be dynamically updated, embodiments of the present disclosure allow the pool of possible cryptographic techniques to be continuously updated to meet new conditions and threats. For example, as new libraries are developed, these libraries may be added to library manager 140, and the cryptographic techniques in the library may be used by crypto provider 120 in servicing requests from application 110 without application 110 having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a new cryptographic technique is tagged as quantum safe, meaning that the cryptographic technique was developed to be resistant to being decoded by quantum computers. For instance, the new cryptographic technique may have a high security rating (e.g., 10 out of 10) as well as high resource requirements. The new cryptographic technique is registered with library manager 140, and information about the new cryptographic technique and its characteristics is stored in available algorithm/configuration table 142. Thus, the new cryptographic algorithm is available to be selected by crypto provider 120 for servicing cryptographic requests from application 110.

Continuing with the example, a policy 134 states that cryptographic requests relating to data that is long-lived (e.g., of a type that must be protected over a long amount of time, such as many years) is to be encrypted using a quantum-safe cryptographic technique if such a technique is available, unless device and/or network resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like.

Thus, when application 110 submits a cryptographic request (e.g., via a call to a generic cryptographic function provided by abstracted crypto API 112) to encrypt an item of long-lived data, crypto provider 120 determines based on information stored in policy table 132 that a quantum-safe cryptographic technique is to be used if possible. Crypto provider 120 determines based on information in available algorithm/configuration table 142 that the new cryptographic technique is quantum-safe. Next, crypto provider 120 analyzes resource constraints related to the cryptographic request to determine if the new cryptographic technique can be performed. If crypto provider 120 determines that the device and/or network associated with application 110 can support the new cryptographic technique (e.g., based on available resources), then crypto provider 120 selects the new cryptographic technique for servicing the cryptographic request.

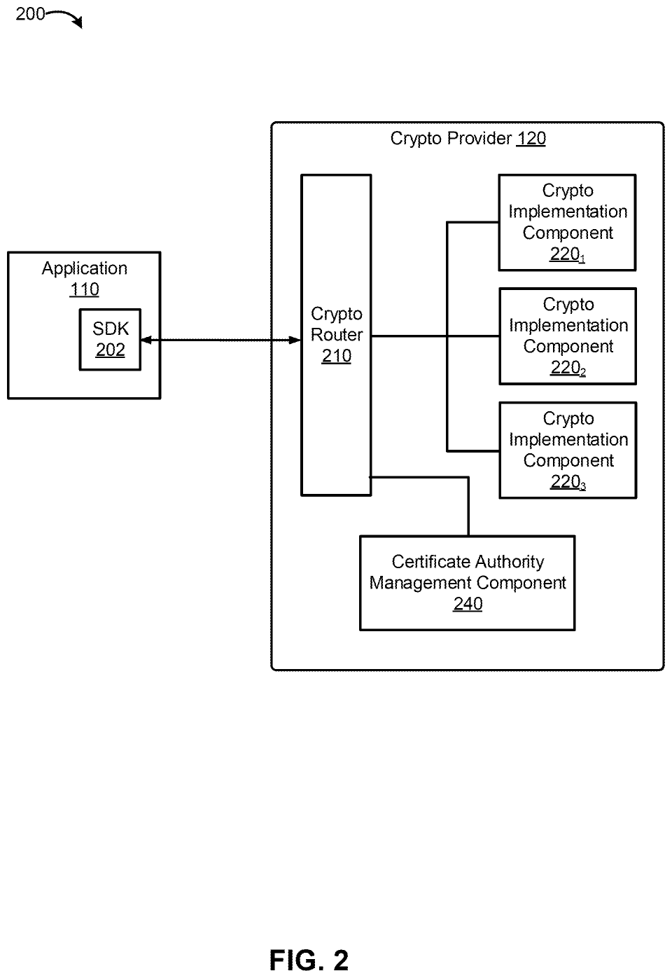

As described in more detail below with respect to FIG. 2, a cryptographic router of crypto provider 120 may route the cryptographic request to a cryptographic implementation component associated with the new cryptographic technique for performing encryption according to the new cryptographic technique. For example, if there is no running cryptographic implementation component for the new cryptographic technique, the cryptographic router may load such a cryptographic implementation component for performing the requested cryptographic operation.

Crypto provider 120 provides a response to application 110 (e.g., via agility shim 114) accordingly. In some cases, the response sent from crypto provider 120 to application 110 includes data encrypted using the selected technique. In other cases, the response includes information related to performing the selected technique to encrypt the data, and the encryption is performed by the entity from which the request was sent. In still other cases, crypto provider 120 may send encrypted data to a different component based on the request and/or may send the data to a separate encryption component to perform the encryption.

In some cases, more than one cryptographic technique may be selected for servicing a given cryptographic request. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations). For example, a dual or multi-encryption scheme such as composite encryption or hybrid encryption may be employed for servicing a single cryptographic request. In some embodiments, one or more homomorphic encryption techniques and one or more confidential computing techniques may be selected to service a single cryptographic request.

It is noted that, in some embodiments, techniques described herein for providing cryptography as a service may eliminate the need for applications to independently implement cryptographic functionality and/or secure communication protocols such as transport layer security (TLS), as applications can instead utilize the cryptographic functionality provided by a crypto provider 120.

In some embodiments, a service instance is implemented in the form of a pod that includes multiple containers, including a main container and one or more sidecar containers, which are responsible for supporting the main container. For instance, a main container may be a content server and a sidecar container may perform logging functions for the content server, with the content server and the logging sidecar container sharing resources such as storage associated with the pod. A service deployment may include one or more pods, individual containers, virtual machines (VMs), and/or other virtual computing instances (VCIs). For example, application 110 may be a main container and generic cryptography module 118 may be a sidecar container within the same service instance. This is included as an example implementation, and other implementations are possible. For example, generic cryptography module 118 may be independent of application 110, such as running on the same or a different device. In one example implementation, the functionality described herein with respect to generic cryptography module 118 is implemented by a hypervisor of a virtualized computing system. For example, application 110 may be a VCI or may run on a VCI, and the hypervisor that supports the VCI may provide the functionality of generic cryptography module 118, such as receiving cryptographic requests from application 110 and dynamically providing requested cryptographic functionality.

In one example, crypto provider 120 is included on an edge device in a networking environment, and any service running on the edge device (or, in some embodiments, any service in the networking environment or on some subset of devices in the networking environment) can make a call to crypto provider 120 (e.g., via an API) to perform cryptographic functionality. For example, an application running on the edge device may issue a request to crypto provider 120 to encrypt data that is to be sent to an aggregator device as part of a federated learning process, and crypto provider 120 may dynamically select a cryptographic technique (e.g., a homomorphic encryption technique) and/or perform additional operations (e.g., negotiating with other endpoints involved in the federated learning process to select a cryptographic technique that is compatible with all of the endpoints' attributes and/or requirements) in order to provide the requested cryptographic functionality without the application needing to implement any cryptographic logic.

In some embodiments, crypto provider 120 includes multiple interfaces for interacting with different components. For example, crypto provider 120 may include a northbound interface for communicating with a management plane (e.g., to receive policy information), a southbound interface for communicating with developers, and an east/west interface for communicating with other crypto providers, such as to negotiate and/or coordinate aspects of cryptographic functionality.

The abstracted interface provided by the cryptographic agility system described herein can hide details of underlying hardware from end users and requesting applications. For example, if particular types of hardware and/or functionality are required and/or utilized to implement cryptographic techniques that are dynamically selected by crypto provider 120 as described herein, the requesting applications and associated users may benefit from the cryptographic functionality without being aware of the hardware and/or capabilities involved in the process, such that the challenges involved are abstracted away from end users and applications.

FIG. 2 is an illustration 200 of an example related to cryptography as a service. Illustration 200 includes application 110 and crypto provider 120 of FIG. 1.

Application 110 sends requests for cryptographic functionality to crypto provider 120, such as via a software development kit (SDK) 202, which may include methods exposed by an API of crypto provider 120. Cryptographic requests from application 110 (and/or one or more additional applications) are received by crypto router 210, which dynamically selects crypto implementation components 220 for handling the cryptographic requests.

Crypto implementation components 220₁, 220₂, and 220₃ (collectively, crypto implementation components 220) generally represent components that perform cryptographic operations according to particular cryptographic techniques. For example, each crypto implementation component 220 may be a software module (e.g., created by a provider of one or more particular encryption algorithms) that encrypts and/or decrypts data using one or more particular encryption algorithms.

Crypto implementation components 220 may, in some embodiments, be added to crypto provider 120 when the corresponding cryptographic techniques are added to the crypto library, and may be loaded (e.g., on demand) for use in handling cryptographic requests. Loading a crypto implementation component 220 may, for example, involve launching an executable software application. It is noted that, while crypto implementation components 220 are depicted within crypto provider 120, alternative embodiments may involve one or more crypto implementation components 220 being located separately from crypto provider 120, such as on the same device or one or more different devices.

In an example, application 110 calls a function of an abstracted crypto API provided by agility shim, which then sends a corresponding crypto request to crypto provider 120, such as for encrypting an item of data for use in a secure multiparty aggregation process. Crypto router 210 determines whether there are any policies applicable to the crypto request, such as based on whether any contextual information related to the request (e.g., relating to the requesting device, application, and/or user, one or more attributes of an aggregator device, the type of data being encrypted, mathematical operations that are to be performed on the encrypted data, and/or the like) corresponds to a policy. If any policies apply, crypto router 210 will ensure that any cryptographic techniques selected comply with the applicable policies.

Crypto router 210 may also consider resource constraints related to the involved devices, applications, and/or networks when selecting cryptographic techniques. For instance, crypto provider 120 may gather performance metrics indicating one or more of current and/or historic processor and memory availability on involved devices, and/or information about capabilities of involved devices (e.g., total amount of processing and memory resources, whether involved devices support accelerator functionality, whether involved devices support particular types of cryptographic techniques, processing speed of involved devices, and/or the like). Furthermore, in some embodiments, crypto provider 120 may gather information about one or more networks related to the request, such as a type of network (e.g., satellite-based, land network, or the like) and/or network performance information (e.g., latency, throughput, packet loss, and/or the like).

Crypto router 210 then selects a cryptographic technique for servicing the crypto request based on any applicable policies and the gathered contextual information. For instance, upon determining that a requesting device is located on a satellite-based network and/or a network that has a high latency, crypto router 210 may select a cryptographic technique with a low network resource utilization rating.

In some cases, crypto router 210 may select a cryptographic technique based on tags associated with the cryptographic technique, such as indicating the security rating and/or resource requirements of the cryptographic technique. Crypto router 210 may first determine which potential cryptographic techniques comply with applicable policies (e.g., meeting a required security rating or being of a required type of cryptography such as homomorphic), and may then determine which of those policy-compliant techniques are consistent with the resource constraints related to the crypto request. Finally, crypto router 210 may select a cryptographic technique from a subset of available cryptographic techniques that includes those techniques that are both policy-compliant and resource-compliant. For example, crypto router 210 may select the most secure cryptographic technique and/or the most resource-efficient cryptographic technique in the set of policy-compliant and resource-compliant techniques.

Crypto router 210 then forwards at least a subset of data from the cryptographic request to a particular crypto implementation component 220 that implements the selected cryptographic technique. If there is no such crypto implementation component 220 currently running, then crypto router 210 may load such a crypto implementation component 220 for use in handling the cryptographic request. The crypto implementation component 220 then performs the selected cryptographic technique in order to encrypt the data, and then returns the encrypted data to crypto router 210. Crypto router 210 then returns the encrypted data to application 110 in response to the cryptographic request and/or provides the encrypted data to one or more separate endpoints (e.g., indicated in the cryptographic request).

Crypto router 210 may also re-route handling of cryptographic requests over time based on changing circumstances. For example, if application 110 indicates that it would like to change to a different cryptographic technique, or if crypto router 210 automatically determines that a more optimal cryptographic technique is available for handling a given cryptographic request under changed circumstances or due to a new cryptographic technique becoming available, crypto router 210 may dynamically transfer handling of the cryptographic request from one crypto implementation component 220 to another. For instance, if the cryptographic request relates to a series of encryption operations, crypto router 210 may wait until any in-process cryptographic operations are completed by a first crypto implementation component 220 and then transfer handling of the request to a second crypto implementation component 220 for performing subsequent cryptographic operations related to the cryptographic request. Thus, crypto router 210 may ensure that cryptographic requests are handled in an optimal manner over time, even as circumstances change and different cryptographic techniques become well-suited to a particular cryptographic request.

In some embodiments, crypto router 210 may also route requests to different instances of the same crypto implementation component 220, such as to achieve load balancing objectives, prioritization objectives, and/or other types of objectives. For example, multiple instances of a given crypto implementation component 220 may be loaded (e.g., as needed), and crypto router 210 may distribute requests across the multiple instances of the crypto implementation component 220 according to policies, information related to the requests, computing resource (e.g., processor, memory, and/or storage resources) utilization associated with the instances of the crypto implementation component 220, numbers of requests being handled by each instance of the crypto implementation component 120, and/or the like. Crypto router 210 may, for example, launch instances of a crypto implementation component 120 as needed and shut down instances that are no longer needed (e.g., instances that have not processed a request for a threshold amount of time).

Crypto provider 120 also includes a certificate authority (CA) management component 240. CA management component 240 may manage the selection of certificate authorities for providing secure certificates related to cryptographic techniques implemented by crypto implementation components 220, such as public key infrastructure (PKI) certificates for use with various encryption techniques.

In cryptography, a certificate (e.g., public key certificate, digital certificate, or identity certificate) is an electronic document used to prove ownership of a key. A certificate may include, for example, information about a key, information about the identity of a key's owner (sometimes referred to as the subject of the certificate), and a digital signature of an entity that has verified the certificate's validity (sometimes referred to as the issuer of the certificate). If an application analyzing the certificate determines that the signature is valid, and trusts the issuer, then it may determine that is can use the key to communicate securely with the subject of the certificate. Different cryptographic algorithms, involving different keys and types of keys, require different certificates.

Crypto provider 120 may select a corresponding certificate for use with a selected cryptographic technique. CA management component 240 may maintain characteristics of a plurality of certificates, such as metadata that identifies the cryptographic techniques to which the certificates correspond. In some embodiments, CA management component 240 may obtain and/or generate certificates upon request, store pre-generated certificates, interact with one or more separate components for generation and/or digital signing of certificates, and/or the like. For example, CA management component 240 may check to see if a pre-generated certificate is available for use with a selected cryptographic technique and, if not, may generate or obtain a new certificate that corresponds to the selected cryptographic technique.

Certificate authorities may register components with crypto provider 120, such as plugins or other types of applications, and these components may be used by CA management component 240 to obtain signed certificates. For example, CA management component 240 may communicate with a plugin correspond to a particular certificate authority that is capable signing a certificate corresponding to a selected cryptographic technique in order to obtain a signed certificate. Furthermore, CA management component 240 may ensure that certificate authorities are changed over time as appropriate, such as in response to a change in cryptographic technique.

By abstracting details of certificate management away from requesting applications such as application 110, techniques described herein allow the cryptographic agility system to dynamically select and provide certificates for use with dynamically-selected cryptographic techniques to enable seamless cryptographic agility without requiring the requesting applications to be directly involved in the process.

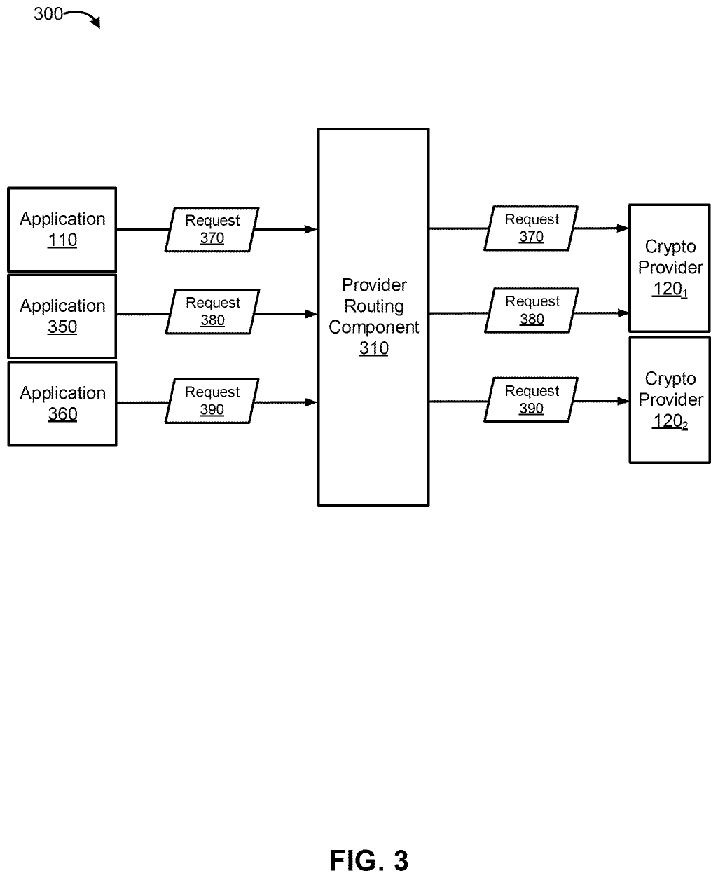

FIG. 3 is an illustration 300 of another example related to cryptography as a service. In particular, illustration 300 shows a mechanism for improving performance and increasing scalability of techniques described herein through the use of a provider routing component 310. Illustration 300 includes application 110 and two crypto providers 1201 and 1202, which may be separate instance or separate threads of crypto provider 120 of FIGS. 1 and 2.

Multiple applications, such as application 110 and applications 350 and 380 (e.g., which may be different applications running on the same or different device(s) as application 110) may submit cryptographic requests to the cryptographic agility system described herein. For example, applications 110, 350, and 360 issue requests 370, 380, and 390, such as by making API calls. According to certain embodiments, a provider routing component 310 is configured to receive requests 370, 380, and 390, and to route these requests to appropriate crypto provider(s) 120. For example, provider routing component 310 may be an upstream component from crypto provider(s) 120, and may intercept and/or otherwise receive requests issued to crypto provider(s) 120.

Provider routing component 310 may perform request optimization, including load balancing, and/or prioritization functionality, such as by distributing requests to crypto provider(s) 120 according to load, priority, and/or other criteria. In some embodiments, provider routing component 310 launches additional crypto provider(s) 120 as needed over time. For example, once processing and/or storage resource utilization associated with a first crypto provider 120₁ reaches a certain threshold (e.g., after routing requests 370 and 380 to crypto provider 120₁) and/or when a threshold number of requests are currently being handled by crypto provider 120₁, provider routing component 310 may launch an additional crypto provider 1202 and route subsequent requests (e.g., request 390) to crypto provider 120₂. Furthermore, provider routing component 310 may shut down crypto providers that are not needed, such as when a given crypto provider 120 has not handled any requests for a threshold amount of time.

Provider routing component 310 may determine priorities of requests, such as based on policies and/or context information related to the requests, and may route requests to crypto provider(s) 120 according to the determined priorities. For example, requests with a higher priority may be routed to crypto provider(s) before those with a lower priority, and/or higher-priority requests may be routed to crypto provider(s) 120 with lower amounts of load (e.g., with higher amounts of available computing resources). In one example, requests associated with particular users or organizations, particular types of data, and/or otherwise indicated to be time-sensitive, may be assigned higher priorities than requests associated with different users or organizations, different types of data, and/or otherwise not indicated to be time-sensitive. These prioritization factors are included as examples, and other factors may also be considered. In some embodiments, provider routing component 310 implements one or more quality of service (QoS) objectives, such as routing requests to crypto providers 120 in order to ensure certain QoS metrics (e.g., levels of performance, maximum amounts of latency, required throughput, and/or the like) are achieved.

Crypto provider(s) 120 may comprise separate crypto provider instances and/or may comprise separate threads of a single crypto provider instance. In certain embodiments, each crypto provider 120 provides the same functionality as other crypto provider(s) 120, such as being launched based on the same underlying code. In one example, crypto provider(s) 120 are deployed based on code received from a central component of a cryptographic agility system, where the central component distributes a crypto provider package to various endpoints.

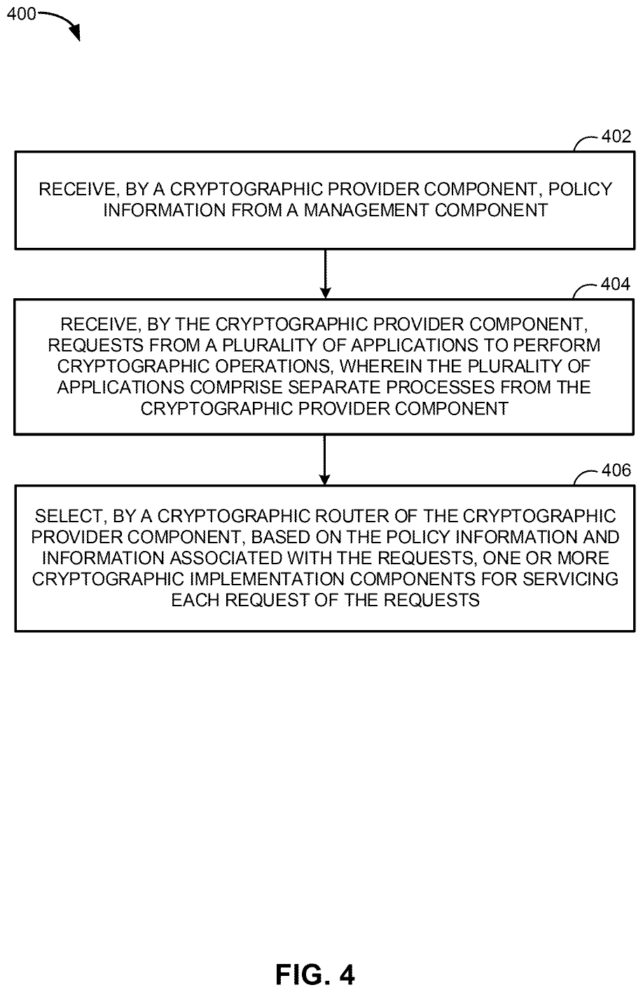

FIG. 4 depicts example operations 400 related to providing cryptography as a service according to embodiments of the present disclosure. For example, operations 400 may be performed by one or more components of the cryptographic agility system described above with respect to FIGS. 1-3.

Operations 400 begin at step 402, with receiving, by a cryptographic provider component, policy information from a management component.

Operations 400 continue at step 404, with receiving, by the cryptographic provider component, requests from a plurality of applications to perform cryptographic operations, wherein the plurality of applications comprise separate processes from the cryptographic provider component.

Operations 400 continue at step 406, with selecting, by a cryptographic router of the cryptographic provider component, based on the policy information and information associated with the requests, one or more cryptographic implementation components for servicing each request of the requests.

Some embodiments further comprise determining, by the cryptographic router, a policy-related event based on the policy information.

Some embodiments further comprise transferring, by the cryptographic router, servicing of at least one request of the requests from a first cryptographic implementation component to a second cryptographic implementation component based on the policy-related event.

Certain embodiments further comprise selecting, by the cryptographic provider component, certificate authorities for generating one or more security certificates related to the requests. For example, the certificate authorities may be selected by certificate authority management component 240 of FIG. 2, such as based on certificate authorities that have been registered with the cryptographic provider component.

Some embodiments further comprise loading, by the cryptographic provider component, the one or more cryptographic implementation components selected for servicing each request of the requests based on a library of available cryptographic techniques associated with the cryptographic provider component. In certain embodiments, the one or more cryptographic implementation components selected for servicing each request of the requests implement one or more cryptographic techniques of the available cryptographic techniques in the library.

In some embodiments, the requests were routed to the cryptographic provider component by a provider routing component separate from the cryptographic provider component, and wherein the provider routing component routes additional requests to one or more other cryptographic provider components. For example, the provider routing component may perform load balancing for the requests and the additional requests among the cryptographic provider component and the one or more other cryptographic provider components.

Certain embodiments further comprise launching, by the provider routing component, the one or more other cryptographic provider components based on an amount of load associated with the cryptographic provider component.

In some embodiments, a load balancing decision related to the load balancing is made by a load balancing component separate from the provider routing component.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of providing cryptography as a service, comprising:
receiving, by a cryptographic provider component, policy information;
receiving, by the cryptographic provider component, requests from a plurality of applications to perform cryptographic operations, wherein the plurality of applications comprise separate processes from the cryptographic provider component; and
selecting, by a cryptographic router of the cryptographic provider component, based on the policy information and information associated with the requests, one or more cryptographic implementation components for servicing each request of the requests.

2. The method of claim 1, further comprising:
determining, by the cryptographic router, a policy-related event based on the policy information; and
transferring, by the cryptographic router, servicing of at least one request of the requests from a first cryptographic implementation component to a second cryptographic implementation component based on the policy-related event.

3. The method of claim 1, further comprising selecting, by the cryptographic router, certificate authorities for generating one or more security certificates related to the requests.

4. The method of claim 1, further comprising loading, by the cryptographic provider component, the one or more cryptographic implementation components selected for servicing each request of the requests based on a library of available cryptographic techniques associated with the cryptographic provider component.

5. The method of claim 4, wherein the one or more cryptographic implementation components selected for servicing each request of the requests implement one or more cryptographic techniques of the available cryptographic techniques in the library.

6. The method of claim 1, wherein the requests were routed to the cryptographic provider component by a provider routing component separate from the cryptographic provider component, and wherein the provider routing component routes additional requests to one or more other cryptographic provider components.

7. The method of claim 6, wherein the provider routing component performs load balancing for the requests and the additional requests among the cryptographic provider component and the one or more other cryptographic provider components.

8. The method of claim 7, further comprising launching, by the provider routing component, the one or more other cryptographic provider components based on an amount of load associated with the cryptographic provider component.

9. The method of claim 8, wherein a load balancing decision related to the load balancing is made by a load balancing component separate from the provider routing component.

10. A system for providing cryptography as a service, comprising:
at least one memory; and
at least one processor coupled to the at least one memory, the at least one processor and the at least one memory configured to:
receive, by a cryptographic provider component, policy information;
receive, by the cryptographic provider component, requests from a plurality of applications to perform cryptographic operations, wherein the plurality of applications comprise separate processes from the cryptographic provider component; and
select, by a cryptographic router of the cryptographic provider component, based on the policy information and information associated with the requests, one or more cryptographic implementation components for servicing each request of the requests.

11. The system of claim 10, wherein the at least one processor and the at least one memory are further configured to:
determine, by the cryptographic router, a policy-related event based on the policy information; and
transfer, by the cryptographic router, servicing of at least one request of the requests from a first cryptographic implementation component to a second cryptographic implementation component based on the policy-related event.

12. The system of claim 10, wherein the at least one processor and the at least one memory are further configured to select, by the cryptographic router, certificate authorities for generating one or more security certificates related to the requests.

13. The system of claim 10, wherein the at least one processor and the at least one memory are further configured to load, by the cryptographic provider component, the one or more cryptographic implementation components selected for servicing each request of the requests based on a library of available cryptographic techniques associated with the cryptographic provider component.

14. The system of claim 13, wherein the one or more cryptographic implementation components selected for servicing each request of the requests implement one or more cryptographic techniques of the available cryptographic techniques in the library.

15. The system of claim 10, wherein the requests were routed to the cryptographic provider component by a provider routing component separate from the cryptographic provider component, and wherein the provider routing component routes additional requests to one or more other cryptographic provider components.

16. The system of claim 15, wherein the provider routing component performs load balancing for the requests and the additional requests among the cryptographic provider component and the one or more other cryptographic provider components.

17. The system of claim 16, wherein the at least one processor and the at least one memory are further configured to launch, by the provider routing component, the one or more other cryptographic provider components based on an amount of load associated with the cryptographic provider component.

18. The system of claim 17, wherein a load balancing decision related to the load balancing is made by a load balancing component separate from the provider routing component.

19. A non-transitory computer readable medium storing instructions that, when executed by one or more processors, cause the one or more processors to:
receive, by a cryptographic provider component, policy information;
receive, by the cryptographic provider component, requests from a plurality of applications to perform cryptographic operations, wherein the plurality of applications comprise separate processes from the cryptographic provider component; and
select, by a cryptographic router of the cryptographic provider component, based on the policy information and information associated with the requests, one or more cryptographic implementation components for servicing each request of the requests.

20. The non-transitory computer readable medium of claim 19, wherein the instructions, when executed by the one or more processors, further cause the one or more processors to:
determine, by the cryptographic router, a policy-related event based on the policy information; and
transfer, by the cryptographic router, servicing of at least one request of the requests from a first cryptographic implementation component to a second cryptographic implementation component based on the policy-related event.
